(19) United States
(12) Patent Application Publication
(10) Pub. No.: US 2020/0311762 A1
(43) Pub. Date: Oct. 1, 2020

(54) SYSTEM AND METHOD FOR ANALYZING THE EFFECTIVENESS AND INFLUENCE OF DIGITAL ONLINE CONTENT

(71) Applicant: Heng Xu, Shanghai (CN)

(72) Inventor: Heng Xu, Shanghai (CN)

(21) Appl. No.: 16/430,238

(22) Filed: Jun. 3, 2019

Related U.S. Application Data
(62) Division of application No. 16/367,118, filed on Mar. 27, 2019.

(51) Int. Cl. G06Q 30/02; G06F 16/903; G06F 17/18

(52) U.S. Cl. CPC G06Q 30/0242; G06F 17/18; G06F 16/903

(57) ABSTRACT

A system and method for detecting the influence of digital content. A computer-implemented system and method serves to analyze the influence of an underlying subject based on a plurality of parameters such as word-of-mouth factor, ranking visibility factor, trending factor and appearance percentage thereby effectively and comprehensively evaluating the online influence of a brand or other underlying subject.

### CROSS-REFERENCE

This application is a division of, and claims priority to, U.S. patent application Ser. No. 16/367,118 filed Mar. 27, 2019 which is incorporated herein for all purposes.

### FIELD OF THE INVENTION

The embodiments of the present invention relate to analyzing digital media to determine the effectiveness of subject content.

### BACKGROUND

In today's society, the Internet is the primary mechanism for disseminating content. When a person or organization needs information, the first option is to conduct an online search. Internet advertising appears in all online platforms including video, portals, vertical portals, search and others. It is easy to forget that the content is more important than the advertising since many consumers are not influenced by advertisements but rather the evaluations, opinions, science of their peers.

However, one significant question is the value of the content dissemination to the disseminator. That is, how effective is the content dissemination at fulfilling its objective.

Thus, it would be advantageous to develop a system and method for evaluating a website, product and/or brand in the digital space based on a plurality of parameters, including word-of-mouth factor, ranking visibility factor, trending factor (e.g., search volume, keyword popularity, etc.) and appearance percentage (aka frequency of appearances over total number of search results) so that the owner of the subject website, product and/or brand may strategize to improve the Internet influence of the website, product and/or brand rather than rely on blind advertising. The benefits of advertising may also be evaluated using the embodiments of the present invention.

### SUMMARY

The embodiments of the present invention are directed to a computer-implemented method for detecting an influence of the presence of an underlying subject on the Internet comprising: utilizing a processor, a computer terminal and a network collectively configured to access Internet websites conducting one or more keyword searches using an Internet search tool; analyzing a pre-established number of search results based on the one or more keyword searches to identify relevant search results, the relevant search results related to the underlying subject; based on the relevant search results, calculating the influence of the Internet presence of the underlying subject based on at least a word-of-mouth factor and ranking visibility factor; and wherein the word-of-mouth factor of the relevant search results is indicative of the perception or reputation of the underlying subject and the ranking visibility factor is indicative of the position of the relevant search result within the pre-established number of search results.

In one embodiment, the underlying subject is one or more combinations of a brand name, product name, company CEO name, company slogan, or a competing product and the keyword or keywords may include: a consumer demand word, or one or more combinations of brand words, brand extension words, business words and competing words.

In one embodiment, the manner of calculating the word-or-mouth factor includes: calculating a perception of the underlying subject using search result links depicted on one or more initial search results pages, said one or more initial search results pages including a title and abstract of individual search results and/or calculating a perception of the underlying subject using content accessed within said one or more search result links.

In one embodiment, the ranking visibility factor of an underlying subject is based on the position of relevant search results within a pre-established number of search results (e.g., 30) wherein each search result position has a corresponding ranking visibility factor and each search page is weighted with a first page being most important, a second page being less important and so on.

In another embodiment, the manner of calculating the word-of-mouth factor is based on the reputation of the underlying subject obtained by using search result links depicted on one or more initial search result pages including: performing word-of-mouth factor analysis of the context in which the title and abstract of each search result are located, and determining, based on the word-of-mouth factor analysis result; wherein the word-of-mouth factor analysis result is either positive, negative or neutral; calculating a ratio of the number of search results being positive and neutral to the total number of search results associated with the underlying subject; and calculating a reputation percentage of the underlying subject.

In another embodiment, the manner of calculating the word-of-mouth factor is based on the reputation of the underlying subject obtained by using content associated with search result links depicted on one or more initial search results pages including: determining the position of the underlying subject in each position in the content associated with the search result links; performing a word-of-mouth factor analysis of the context in which the underlying subject is located in the content and obtaining a word-of-mouth analysis result of each position; evaluating the word-of-mouth analysis result for each position to obtain the word-of-mouth factor analysis result of the collective search results; assigning a weight based on a proximity of the word-of-mouth factor analysis result of each search result to a positive word-of-mouth; calculating a ratio of the number of search results to the total number of search results associated with the underlying subject, the ratio used to determine the perception of the underlying subject.

In another embodiment, the word-of-mouth analysis results of the respective positions include non-negative evaluations and negative evaluations wherein the non-negative evaluations include positive evaluations and neutral evaluations such that when the word-of-mouth analysis results of all positions are non-negative, deeming the word-of-mouth analysis results of the search result to be positive and providing a highest weight for the search results; wherein when non-negative word-of-mouth analysis results of positions are greater than negative word-of-mouth analysis results of positions, deeming the word-of-mouth analysis results of the search result to be positive and assigning a high weight; wherein when the non-negative word-of-mouth analysis results of the positions are equal in number to the negative word-of-mouth analysis results of the positions, deeming the word-of-mouth analysis results of the search result to be neutral and assigning a medium weight for the search result; wherein if the non-negative word-of-mouth analysis results for positions are less than the negative word-of-mouth analysis results of the positions, deeming the word-of-mouth analysis result of the search result poor and assigning a low weight; and wherein when the word-of-mouth analysis results of all positions are negative, deeming the word-of-mouth analysis results of the search result to be poor and assigning a lowest weight for the search result.

In one embodiment of the present invention, the word-of-mouth factor is calculated as:

pctₚ=((Count of highest weight,high weight and medium weight)/(Total count of high weight, higher weight,medium weight,low weight and lowest weight))×100%.

In one embodiment of the present invention, the manner of analyzing the ranking visibility factor comprises:

$$p c {t}_{i} = \frac{{x}_{i}}{{\sum }_{1}^{n} {x}_{i}} \times 100 \% ;$$

wherein pctᵢ represents the ranking visibility factor of the iₜₕ search result in the set of search results; xᵢ represents the assignment of the iₜₕ search result on the page; and n represents the number of search results. A preset number of search results are grouped into the same search page and the weighted ranking visibility factor of each search result is calculated according to the weight of the search page in all the search pages by

$$p c {t}_{{weight}_{ij}} = \frac{{x}_{i j}}{{\sum }_{1}^{n} {x}_{ij}} \times {weight}_{j} \times 100 \% ;$$

wherein pct_{weight}, ∈[0%, 100%]; weightⱼ represents the weight of each search page among multiple search pages; and xᵢⱼ represents the assignment of the ranking visibility factor to the iₜh search result position on each search page.

In one embodiment of the present invention, one influence evaluation parameter of the underlying subject includes an appearance percentage, wherein the appearance percentage is used to indicate a proportion of a search result associated with the underlying subject in the set of search results, the appearances percentage comprises:

$$counts\_pct {y}_{1} = \frac{Counts of {y}_{1}}{Total y} \times 100 \% ;$$

wherein y₁ represents a search result of the underlying subject; Counts of y₁ represents the number of times the underlying subject appears; and Total y represents the total number of search results.

In one embodiment of the present invention, the method includes: calculating a word-of-mouth index of a website based on a plurality of unique keywords input into an Internet search tool; obtaining search results from the Internet search tool corresponding to the plurality of unique keywords; calculating the website's word-of-mouth index based on the search results; and calculating the website's word-of-mouth influence index based on the word-of-mouth index and a usage rate of the website during a preset time period (this can be based on website traffic or other parameters); and aggregating the word-of-mouth influence index of each website to generate a corresponding comprehensive word-of-mouth influence index. The comprehensive word-of-mouth influence index being used to represent the underlying subject's word-of-mouth performance across the entire network.

In an embodiment of the present invention, the calculation formula of the website word-of-mouth index is calculated as

$${Web\_pct}_{p} = \frac{{pct}_{p 1} * V 1 + {pct}_{p 2} * V 2 + … + {pct}_{pn} * Vn}{Total V} \times 100 ;$$

wherein pctₚ₁, . . . , pctₚₐ represents that the underlying subject is based on the word-of-mouth factor of the website according to the first to nth keywords; V1, . . . , Vn represents the trending factor of the 1^{st} to the nth keywords on the website; and wherein the trending factor includes any one or more combinations of quantity, volume of interest and/or keyword usage; with the calculation formula of the word-of-mouth influence index being Web_Indexₚ=Web_pctₚ*Web_Mount Percent; wherein Web_Mount Percent represents the usage rate of the website within a preset time period; with the calculation formula of the comprehensive word-of-mouth influence index being Total_Web_Indexₚ=ΣWeb_Indexₚ.

In one embodiment of the present invention, a ranking visibility index is used to indicate the positional performance of the underlying subject across the network. In one embodiment of the present invention, the calculation formula of the ranking visibility index is:

$${Web\_pct}_{s} = \frac{{pct}_{s 1} * V 1 + {pct}_{s 2} * V 2 + … + {pct}_{sn} * Vn}{Total V} \times 100$$

wherein pctₛ₁, . . . , pctₛₘ represents that the underlying subject is based on the ranking visibility factor of the website according to the first to nth keywords, and V1, . . . , Vn represents the trending factor of the 1^{st} to the nth keywords on the website wherein the trending factor includes any one or more combinations of quantity, volume of interest and/or keyword usage; with the calculation formula of the ranking visibility influence index being: Web_Index_{g}=Web_pct_{g}*Web_MountPercent wherein Web_Mount Percent represents the usage rate of the website within a preset time period; and the calculation formula of comprehensive ranking visibility influence index is: Total_Web_Index_{g}=ΣWeb_Index_{g}.

In one embodiment, the system herein is used to determine the effectiveness of online published digital documents. In one such embodiments, the title of the digital document, the URL of the digital document publication website, the keywords for each digital document and the search website are provided by a customer. The system then causes keyword searches to be conducted on the search website. The system then uses the title and URL to find the position of published digital documents from which a ranking visibility factor may be used to determine an effectiveness of the publication.

To achieve the above and other related objects, the embodiments of the present invention utilize a computer readable storage medium storing a computer program that, when executed by a processor, implements the influence detection method applicable to an underlying subject.

To achieve the above and other related objects, the embodiments of the present invention utilize an electronic terminal comprising: a processor and a memory; the memory used to store a computer program, and the processor configured to execute the computer program of the memory to enable the terminal to perform the influence detection method applicable to the underlying subject.

As described above, the influence detection method, the electronic terminal, and the storage medium for the underlying subject have at least the following beneficial effects: analysis of the parameter based on a plurality of influence evaluation parameters such as word-of-mouth factor, ranking visibility factor, trending factor and appearance percentage.

Once the result evaluation parameters are calculated, the system and method may generate one or more visual representations which present a clear understanding of the data which allows improvements to the result evaluation parameters. In other words, based on the resultant data and graphs, a customer is able to generate budgets directed to the optimal media for achieving an objective via the dissemination of digital content.

Other variations, embodiments and features of the present invention will become evident from the following detailed description, drawings and claims.

### BRIEF DESCRIPTION OF THE DRAWINGS

FIG. 1 illustrates a flow chart showing an influence detection method related to an underlying subject;

FIG. 2 illustrates an initial search results page showing links in the form of titles and abstracts;

FIG. 3A illustrates a chart showing relevant search results based on positions according to the embodiments of the present invention;

FIGS. 3B and 3C illustrate ranking visibility factor charts detailing the first three pages of search results for a keyword or keywords according to the embodiments of the present invention;

FIG. 3D illustrates a ranking visibility index chart based on its two primary components comprising ranking visibility factor and trending factor according to the embodiments of the present invention;

FIGS. 3E and 3F illustrate a word-of-mouth factor chart and word-of-mouth index chart, respectively, based on two primary components comprising word-of-mouth factor and trending factor according to the embodiments of the present invention;

FIG. 4 illustrates a two-dimensional matrix analysis diagram based on trending factor and ranking visibility factor according to the embodiments of the present invention;

FIG. 5 illustrates a diagram showing a two-dimensional matrix analysis based on a comparison of trending factor and ranking visibility factor between a customer and a competitor according to the embodiments of the present invention;

FIG. 6 illustrates a two-dimensional matrix analysis diagram based on ranking visibility factor and word-of-mouth factor according to the embodiments of the present invention;

FIG. 7 illustrates a multi-dimensional matrix analysis diagram based on trending factor, ranking visibility factor and word-of-mouth factor in an embodiment of the present invention;

FIG. 8 illustrates a schematic structural diagram of an electronic terminal according to the embodiments of the present invention;

FIG. 9 illustrates a flowchart detailing a method for measuring the degree of dissemination of a digital document according to the embodiments of the present invention;

FIG. 10 illustrates an initial search results page associated with the method of measuring the degree of dissemination of a digital document according to the embodiments of the present invention;

FIG. 11 illustrates a first chart associated with the method of measuring the degree of dissemination of a digital document according to the embodiments of the present invention;

FIG. 12 illustrates a second chart associated with the method of measuring the degree of dissemination of a digital document according to the embodiments of the present invention;

FIG. 13 illustrates a chart for visualizing a website's effectiveness in terms of analyzing search results based on keywords according to the embodiments of the present invention; and

FIG. 14 illustrates a chart listing ranking visibility factor against exposure to identify a website's effectiveness relative to certain keywords according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

It is to be noted that, in the following description, reference is made to the accompanying drawings in which it is to be understood that other embodiments may be utilized, and changes in mechanical composition, structure, electrical and operation may be made without departing from the spirit and scope of the application. The following detailed description is not to be considered as limiting, and the scope of the embodiments of the present invention is defined by the appended claims.

In addition, the singular forms “a,” “the,” and “includes” the presence of the described features, operations, components, items, categories, and/or groups, but does not exclude the presence of one or more other features, operations, components, components, items, categories, and/or groups. The terms “or” and “and/or” are used to be construed as inclusive or meaning any one or any combination. Therefore, “A, B or C” or “A, B, and/or C” means “any of the following: A; B; C; A and B; A and C; B and C; and A, B and C”.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer or cloud-based hardware/software, other programmable apparatus or other devices to produce a computer-implemented process such that the instructions which execute on the computer or other programmable apparatus provide processes for implementing the functions/acts specified in the flowchart and/or block diagrams.

The embodiments of the present invention involve an influence detection method, an electronic terminal, and a storage medium suitable for an underlying subject, which analyzes the influence of the underlying subject based on a plurality of influence parameters such as word-of-mouth factor, ranking visibility factor, trending factor and number of appearances, thereby effectively and comprehensively evaluating the influence of a brand or other underlying subject. The technical solution of the embodiments of the present invention is explained below in conjunction with specific embodiments. While digital content is the focus below, advertising and other articles may be evaluated and compared using the embodiments of the present invention.

By way of reference, word-of-mouth parameters detailed herein include a word-of-mouth factor as a percentage, a word-of-mouth index related to the word-of-mouth factor and trending factor, a word-of-mouth influence index related to the word-of-mouth index and website usage rate and a comprehensive word-of-mouth influence index related to the sum of the word-of-mouth influence indexes; and ranking visibility parameters include a ranking visibility factor as a percentage, a ranking visibility index related to the ranking visibility factor and trending factor, a ranking visibility influence index related to the ranking visibility index and website usage rate and a comprehensive ranking visibility influence index related to the sum of the ranking visibility influence indexes.

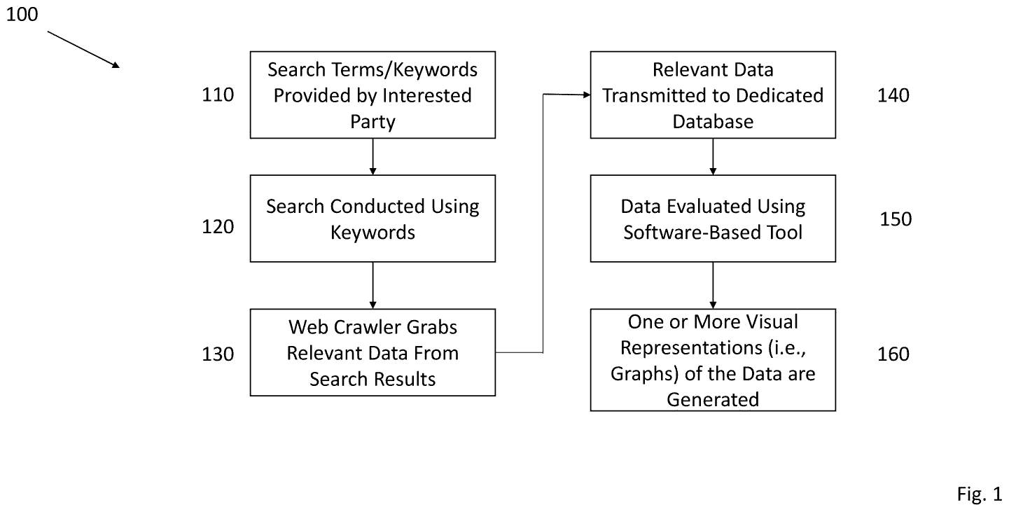

FIG. 1 shows a flow chart 100 detailing a method for detecting an influence of an underlying subject. In this embodiment, the underlying subject refers to a word of interest that the customer is interested in analyzing, such as a brand name, a product name, a company's CEO's name, a company slogan, a slogan or a competing product brand. The influence detection method specifically performs the following steps. At 110, a customer provides keywords (aka search terms) from which the evaluation is to be conducted. The keywords include consumer demand words, brand words, brand extension words, business words, competing brand words and the like wherein consumer demand words refer to terms generated based on consumer demand, such as “which cosmetic is more white,” or “which new energy vehicle is most cost-effective;” brand words refer to a brand name such as “L'Oreal Paris;” brand extension words refer to a keyword generated after the expansion of the brand name, such as “Apple, is the mobile phone expensive;” business words refer to a keyword generated based on the name of the enterprise or the product name or enterprise slogan associated with the brand; and competitive words refer to keywords generated based on a competitor. It should be noted that the classification of the keywords in this embodiment is for reference only and is not a limitation on the implementation method.

At 120, the system searches for a set of search results based on the keyword or keywords. In other words, an Internet search is conducted to identify search results. In one embodiment, 3 pages of search results is evaluated but more or less than 3 pages maybe used to conduct the evaluation. The Internet search may be conducted using a search engine, a social media website, an e-commerce platform, a blog or a microblog platform, a news platform, a question and answer platform, a forum platform, or a video playing platform. More expressly, the search engine is, for example, a Baidu website, a Google website, or a Yahoo website; the social media website is, for example, a WeChat platform or a Facebook platform; the e-commerce platform is, for example, eBay or Amazon; the blog or microblog platform is, for example, a B blog website or a Tumblr blog website; the news platform is, for example, a today's headlines website, CNN news website or MSNBC headline website; the question and answer platform is, for example, Google knows the website; the forum platform is, for example, GetGlue; the video playing platform is, for example, YouTube or BuzzFeed. Advantageously, PC-based websites/webpages and App websites/webpages may be used in conjunction with the embodiments of the present invention.

At 130, the system grabs or scraps the relevant search result data using a web crawler or similar software-based tool. At 140, the data is transmitted to a dedicated database. At 150, the data is evaluated using software tools, artificial intelligence and/or human intervention. The data is evaluated to determine at least three primary parameters, namely ranking visibility factor, word-of-mouth factor and appearance percentages wherein the ranking visibility factor represents how highly ranked the search results are in the total set of search results; the word-of-mouth factor represents a degree of praise based on the underlying subject; and appearance totals indicate how many search results (regardless of rank) relate to the underlying subject.

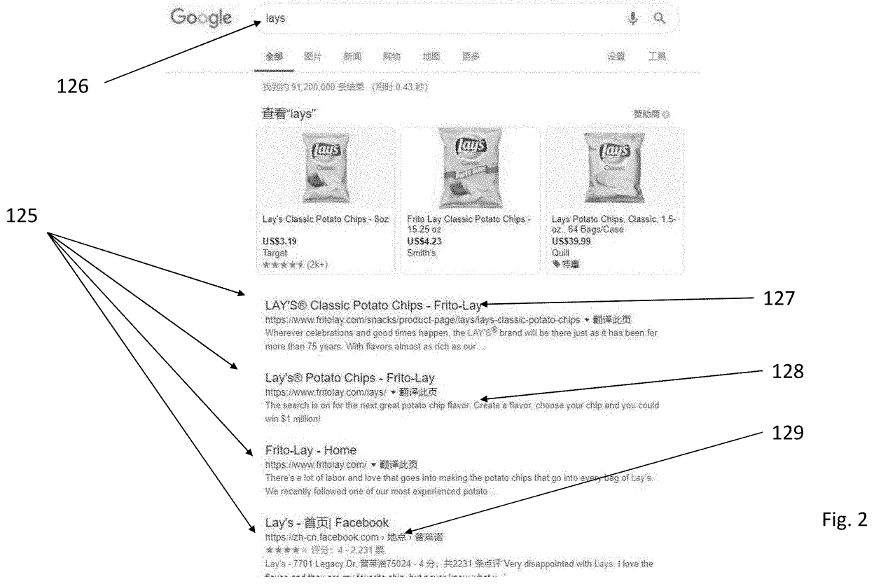

In one embodiment, the manner of calculating the word-of-mouth factor includes: evaluating search results depicted on an initial search results page(s) which generally comprise links in the form of a title and abstract and/or evaluating the content associated with links. FIG. 2 shows a webpage associated with search result links in the form of titles and abstracts. As shown, the search results 125 are based on a Google® search using the keyword “Lays®” 126. As shown, the search results in link form obtained based on the Google® search are displayed on the initial search results page(s). The links include a title 127, abstract 128 and URL 129. The content of the search results may be accessed by clicking the title 127, abstract 128 and URL 129 links. Accordingly, the manner of calculating the word-of-mouth factor may be based on the title and abstract links and/or the content accessible via said links, including the URL 129.

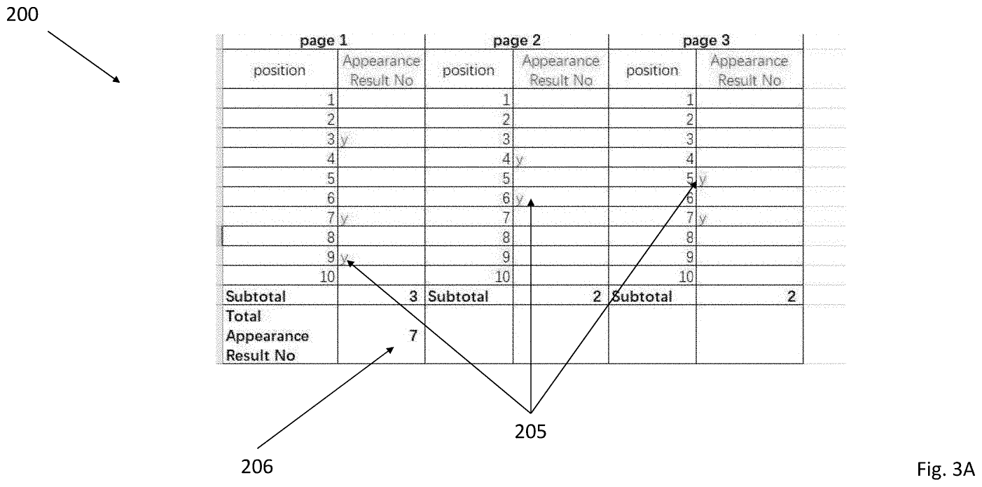

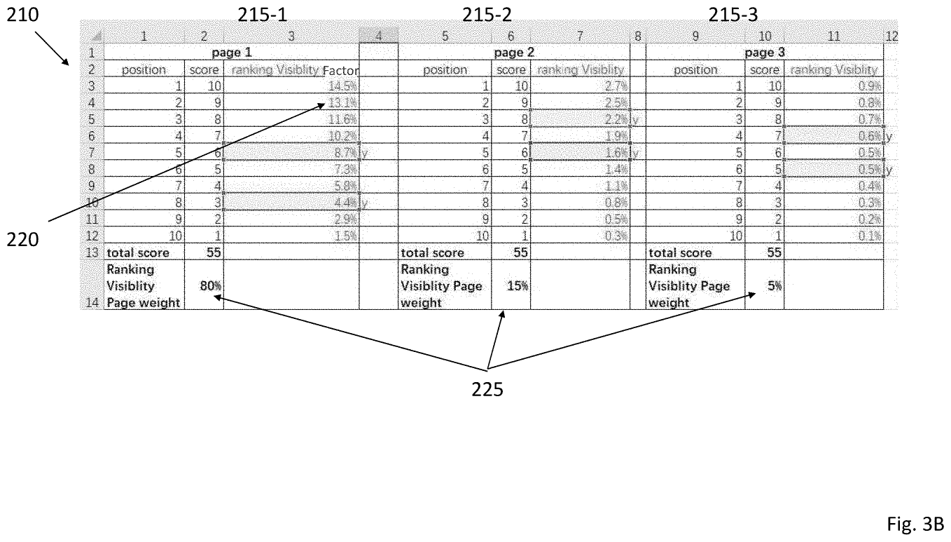

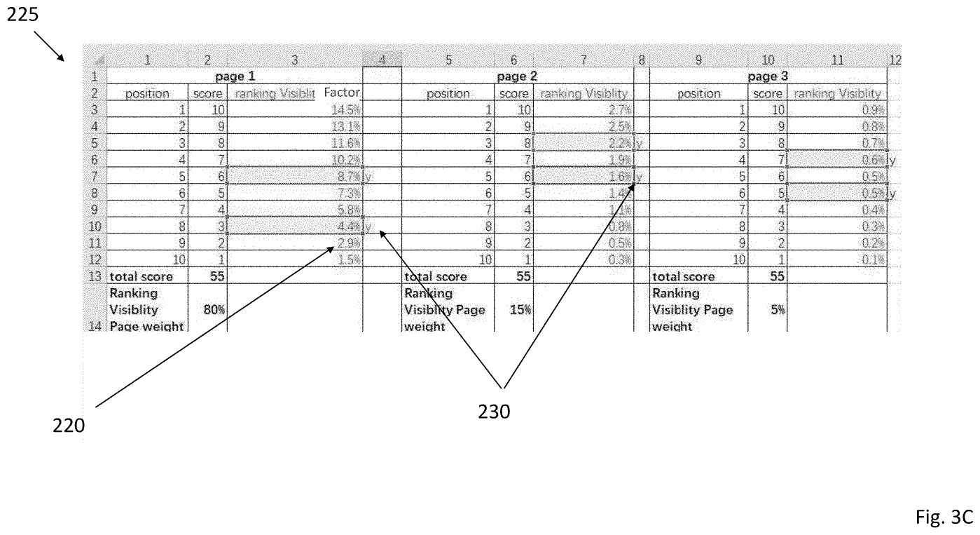

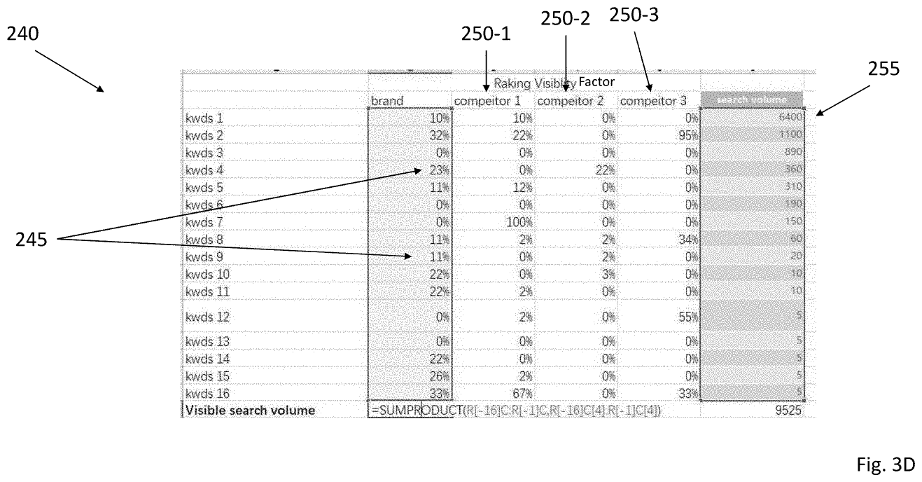

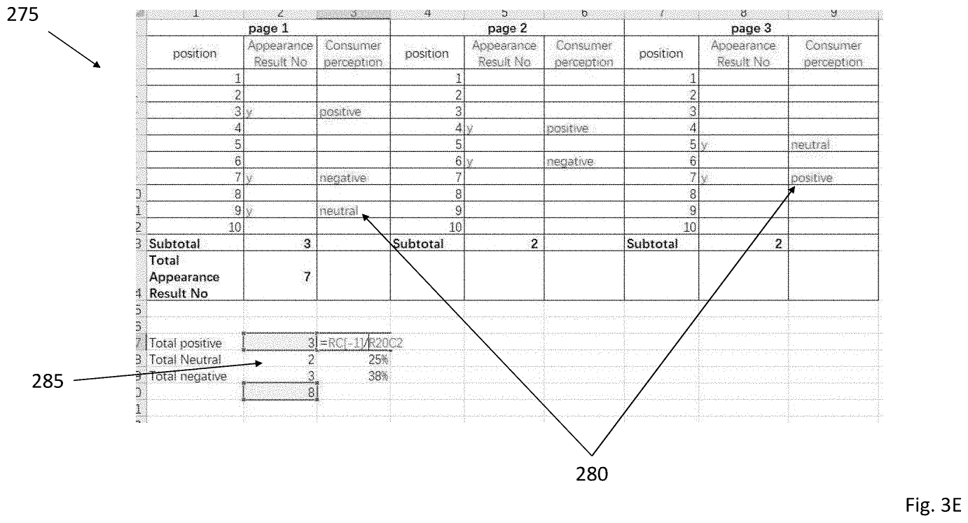

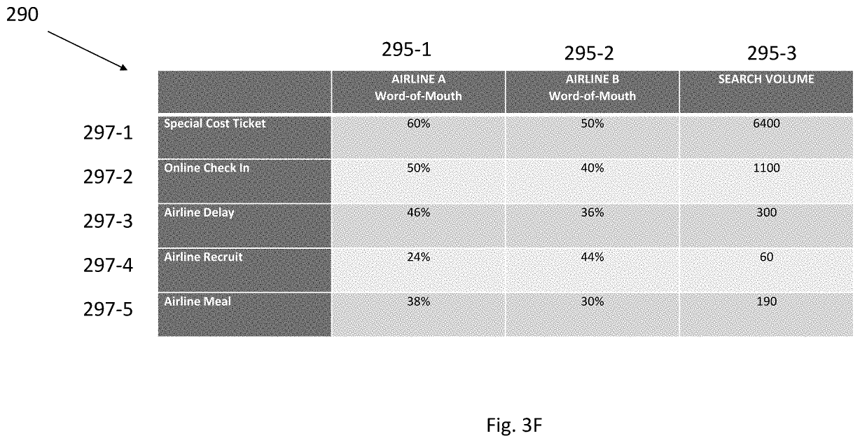

FIG. 3B shows a ranking visibility factor chart 210 detailing the first three pages of search results given a particular keyword or keywords. The chart 210 is segregated into three columns 215-1 through 215-3 with column 215-1 representing the first page of search results; column 215-2 representing the second page of search results; and column 215-3 representing the third page of search results. In this embodiment, each column 215-1 through 215-3 is segregated into ten search results (although this can be more or less depending on the Internet search tool used) with each position given a ranking visibility factor 220 (shown as a percentage) whereby the higher the position of the particular search result, the greater the ranking visibility factor 220. Each column 215-1 through 215-3 representing a search result page is also provided a weight 225 whereby the first page of search results is provided the greatest weight which decreases as the page number increases. As shown, page 1 is weighted 80%, page 2 is weighted 15% and page 3 is weighted 5%. Those skilled in the art will recognize that the weighting scheme shown is exemplary only and may be altered. The ranking visibility factor chart 210 may be populated using data from the initial search results pages depicting title, URL and abstract links and/or the content accessed via the title, URL and abstract links.

FIG. 3C shows ranking visibility factor chart 225 showing certain page positions being identified 230 as depicting relevant search results. From the chart 225, the ranking visibility factor may be calculated. In one embodiment, calculating the ranking visibility factor of the search results associated with the underlying subject comprises:

$$p c {t}_{i} = \frac{{x}_{i}}{{\sum }_{1}^{n} {x}_{i}} \times 100 \% ;$$

wherein pctᵢ presents the ranking visibility factor of the iₜₕ search result item in the set of search result items; xᵢ represents the assignment of the iₜₕ ranking visibility factor 220. The preset number of search results are grouped into the same search page (e.g., 10) and the weighted ranking visibility factor of each search result item is calculated according to the weight of the search page in all the search pages by

$$pc {t}_{{weight}_{ij}} = \frac{{x}_{i j}}{{\sum }_{1}^{n} {x}_{ij}} \times {weight}_{j} \times 100 \% ;$$

wherein pct_{weight}_{ᵢⱼ}∈[0%, 100%]; weights represents the weight of each search page among multiple search pages; and xᵢⱼ represents the assignment of the ranking visibility factor to the iₜₕ search result position on each search page.

FIG. 3D shows a ranking visibility index chart 240 across various unique keywords 245. The ranking visibility index's two primary components comprise ranking visibility factor and trending factor. The chart 240 acts as a comparison against one or more competitors 250-1 through 250-3 based on the identical keywords. Chart 240 also lists the trending factor. In one embodiment, the word-of-mouth factor analysis utilizes a positive evaluation, a neutral evaluation and a negative evaluation. Of course, according to different embodiments, the word-of-mouth index analysis may utilize different classification criteria. FIG. 3E shows a word-of-mouth factor chart 275 indicating whether the relevant search results are positive, neutral or negative 280. Table 285 breaks down the results and determines the word-of-mouth factor. FIG. 3F shows a word-of-mouth index chart 290 comparing different underlying subjects 295-1 through 295-3 and keywords 297-1 through 297-5. The word-of-mouth index's two primary components comprise the word-of-mouth factor and trending factor.

Detailed here is a specific application scenario. The underlying subject is “A brand” and the keyword is “Which is a strong sweeping robot.” Based on the keyword, search results are obtained via an Internet search tool. In one embodiment, three pages of search results are evaluated although a different number of pages may be evaluated. Search results in the search results set to match the “A brand,” for example, the title or abstract may contain “A brand,” or the title and abstract may both include “A brand”. The word of-mouth factor of the “A brand” in the title and abstract of each search result item is analyzed, and a positive evaluation is given 3 points; a neutral evaluation is given 2 points and a negative evaluation is given 1 point. A score of 2 or 3 points is defined as meeting the word-of-mouth requirement. Therefore, the number of search results with scores of 2 and 3 are counted, and the ratio of the total number of search results with scores of 2 and 3 are added and divided by the total number of search results to determine the “A brand” reputation whereby the greater the ratio, the greater the word-of-mouth.

It should be noted that the word-of-mouth factor analysis may be implemented by a semantic analysis algorithm, such as a natural language processing (NLP) algorithm, which uses a method of speculation, probability, statistics, etc., to determine whether the title and abstract is a positive evaluation, a negative evaluation or a neutral evaluation. For example, an emotional lexicon and Bayesian algorithm can be used to classify the text emotions.

In one embodiment, the word-of-mouth factor analysis result of each position includes a non-negative evaluation and a negative evaluation wherein the non-negative evaluation includes a positive evaluation and a neutral evaluation. This analysis relates to the review of the content of the search results rather than the title and abstract located on the initial search results page. That is, the analysis considers comments within the content and assigns a number based thereon as set forth hereinafter. The content is likely to have more information and feedback that may be used to determine the word-of-mouth factor of the underlying subject. If the word-of-mouth analysis of all positions is a non-negative evaluation, assigning the search results a highest weight (e.g., 5 points); if the word-of-mouth analysis results in a number of non-negative evaluation positions being greater than a number of negative evaluation positions, assigning the search results a high weight (e.g., 4 points); if the word-of-mouth analysis results in a number of non-negative evaluation positions equaling a number of negative evaluation positions, assigning the search results a medium weight (e.g., 3 points); if the word-of-mouth analysis results in a number of non-negative evaluation positions being less than a number of negative evaluation positions, assigning the search results a low weight (e.g., 2 points); and if the word-of-mouth analysis of all positions is a negative evaluation, assigning the search results a lowest weight (e.g., 1 point).

In this embodiment, a weight value of 3 points or more is used to determine the word-of-mouth factor, so the word-of-mouth factor can be calculated according to the following formula: pctₚ=(Count of (3˜5 points))/(Total count of (1˜5 points))×100%.

It should be noted that the subjective assignment method and the objective assignment method may be used for the assignment of positive, neutral and negative evaluations. Subjective valuation refers to the calculation of the weight of the original data mainly by the evaluator based on empirical subjective judgment, such as subjective weighting method, expert survey method, analytic hierarchy process, comparative weighting method, multivariate analysis method and fuzzy statistical method. The objective assignment method refers to the calculation of the weight of the original data obtained from the actual data of the evaluation index in the process of evaluation, for example, the variance method, the principal component analysis method, the entropy method, the CRITIC method, etc.

In one embodiment, an appearance percentage is further evaluated. The appearance percentage represents a proportion of search results associated with the underlying subject against all search results wherein the calculation takes the form of:

$$counts\_pct {y}_{1} = \frac{Counts of {y}_{1}}{Total y} \times 100 \% ;$$

wherein y₁ represents a search result of the underlying subject; Counts of y₁ represents the number of times the underlying subject appears; and Total y represents the total number of search results. FIG. 3A shows a chart 200 detailing the relevant search result appearances and positions of each relevant search result 205. As shown, seven 206 out of thirty search results relate to the underlying subject (thus the appearance percentage is 7/30=0.233×100%=23.33%).

The word-of-mouth, the ranking visibility factor, appearance percentage, and the trending factor are four different parameters for describing the influence of the underlying subject. The word-of-mouth factor, ranking visibility factor, appearances percentage and trending factor can be used alone or in combination for a comprehensive analysis.

In one embodiment, the influence detection method further analyzes the performance of the customer on the platform of interest and the relationship between the customer and the competitor by calculating the comprehensive word-of-mouth influence index.

A website word-of-mouth index is calculated according to the reputation of the underlying subject, based on inputting a plurality of unique keywords into an Internet search tool and determining the word-of-mouth index of each keyword on the website. The calculation formula of the website word-of-mouth index is:

$${Web\_pct}_{p} = \frac{{pct}_{p 1} * V 1 + {pct}_{p 2} * V 2 + … + {pct}_{pn} * Vn}{Total V} \times 100 ;$$

wherein, pctₚ₁, . . . , pctₚₙ represents that the underlying subject is based on the word-of-mouth factor of the website according to the first to nth keywords and V1, . . . , Vn represents the search volume of the 1^{st} to n keywords on the website. It should be noted that the specific form of the search volume varies with the network platform and may change with the development of the network platform. For example, the word-of-mouth index of a Google® website mainly refers to the search volume; the word-of-mouth index of today's headline website mainly refers to the search volume, which in this instance weighs and sums the number of behaviors such as reading, analysis or comments of customers related to an event, article or keyword, usually plotted as a trend graph in hours or days, thus showing the change in the search volume with the event; and knowing the word-of-mouth index of the website mainly refers to the topic attention number. Because of the statistical methods of different websites, the search volume may be expressed in different ways.

The word-of-mouth influence index of the website may be calculated using Web_Indexₚ=Web_{pct}_{ₚ}*Web_Mount Percent; wherein Web_Mount Percent represents the usage rate of the website within a preset time period. The word-of-mouth influence indexes of each website on the network are summarized to generate a corresponding comprehensive word-of-mouth influence index. The comprehensive word-of-mouth influence index is used to indicate the word-of-mouth performance of the entire network. The calculation formula of the comprehensive word-of-mouth influence index is Total_Web_Indexₚ=ΣWeb_Indexₚ. It should be noted that because the comprehensive word-of-mouth influence index reflects the superiority and inferior relationship between the customer and the competitive brand, which is closely related to the needs of the consumer, the keyword is preferably a consumer demand word.

In a specific application scenario as shown in FIG. 3F, “Airline A” is taken as the underlying subject and a Google® search tool is used as the default search tool. Keywords such as “special cost ticket,” “online check-in,” “airline delay,” “airline recruit,” and “airline meal” are used as keywords in this embodiment. In this embodiment, it is assumed that “Airline A” is based on the word-of-mouth index based on the Google® search results. The word-of-mouth factor charted is 60%, 50%, 46%, 24%, 38%, respectively. Formula:

$${Web\_pct}_{p} = \frac{\begin{matrix}60 \% * 6400 + 50 \% * 1100 + \\ 46 \% * 300 + 24 \% * 60 + 38 \% * 1900 + …\end{matrix}}{6400 + 1100 + 200 + 60 + 190 + …} \times 100 ,$$

provides the word-of-mouth index for “Airline A” website based on the Google® search results. Using the same calculation principle, the word-of-mouth index of Airline A's competitor's website may be calculated. The competitor airline is shown as Airline B in FIG. 3F.

Other Internet search tools may also be used to determine the word-of-mouth influence index. For convenience of description, this embodiment assumes that “Airline A's” word-of-mouth index is 20 based on the Google® search results; 15 based on the Quora website; and 5 based on the Amazon website. In addition, based on statistics or data provided by third parties, assuming that the number of visitors to each website in the month is 20,000, 30,000, and 40,000, respectively, and assuming that the number of all visitors on the network is 200,000, the usage rates of each website are approximately 20000/200000, 30000/200000, 40000/200000, which is 10%, 15% and 20%, respectively. According to the formula Web_Indexₚ=Web_{pct}_{ₚ}*Web_Mount Percent the word-of-mouth influence index of each website can be calculated, that is, the word-of-mouth influence index of based on the Google® search results, Quora website and Amazon website are 20*0.10, 15*0.15 and, 5*0.2, respectively. According to the size of the word-of-mouth influence index, the performance of the underlying subject on various Internet search tools and the performance of the customer on the same websites as the competitors can be judged, thereby helping the customer to directly compare with its competitors.

The word-of-mouth influence index of each website is calculated to obtain the comprehensive word-of-mouth influence index, Total_Web_Indexₚ=ΣWeb_Indexₚ. The comprehensive word-of-mouth influence index represents a word-of-mouth influence index based on the entire network of the underlying subject.

It should be noted that the calculation of the website word-of-mouth index, the word-of-mouth influence index and the comprehensive word-of-mouth influence index can also be applied to the calculation of ranking visibility index, that is, based on the same calculation principle, the website ranking visibility influence index and the comprehensive website ranking visibility influence index are calculated. Website ranking visibility influence index and website comprehensive ranking visibility influence index are also used to inform customers about their strengths and weaknesses versus their competitors.

Specifically, the calculation formula of the website ranking visibility index is:

$${Web\_pct}_{s} = \frac{{pct}_{s 1} * V 1 + {pct}_{s 2} * V 2 + … + {pct}_{sn} * Vn}{Total V} \times 100 ;$$

wherein, pₛ₁, . . . , pctₛₘ, represents that the underlying subject is based on the ranking visibility factor of the website according to the first to nth keywords; and V1, . . . , Vn represents the trending factor of the 1^{st} to n keywords on the website; wherein the type of trending factor includes a search of any one or more combinations of quantity, volume of interest and/or a keyword usage. The formula for calculating the ranking visibility influence index is: Web_Index_{g}=Web_pctₛ*Web_Mount Percent; wherein Web_Mount Percent represents the usage rate of the website within a preset time period. The formula for calculating the comprehensive ranking visibility influence index is: Total_Web_Index_{g}=ΣWeb_Index_{g}.

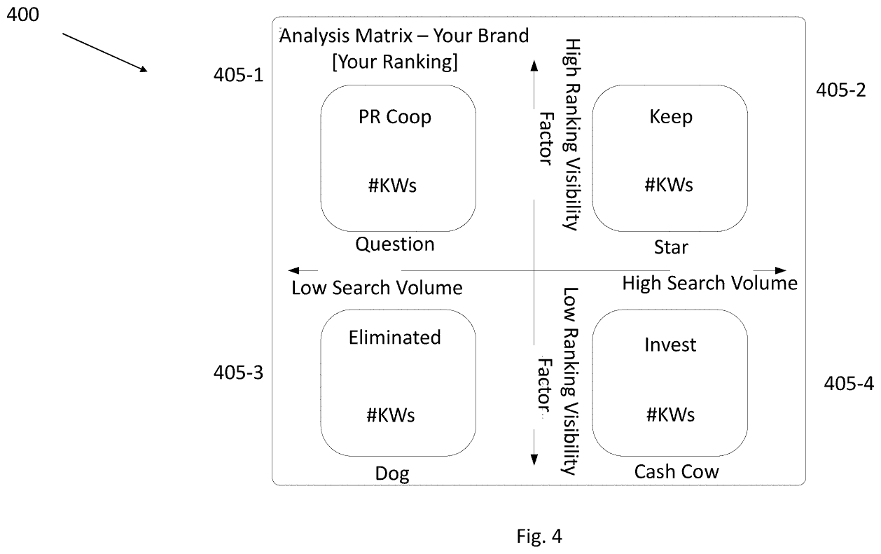

As shown in FIG. 4, a two-dimensional analysis diagram 400 based on trending factor (shown as search volume) and ranking visibility factor is shown. The diagram 400 is divided into four sections 405-1 through 405-4 according to the trending factor and ranking visibility factor. Continuing with “Airline A” as an example: the ranking visibility factor and trending factor of “Airline A” based on the consumer demand keywords falling into the lower left section 405-3 are poor, thus it is not recommended to continue to promote the consumer demand keywords falling into the lower left section 405-3; the ranking visibility factor and trending factor of “Airline A” based on the consumer demand keywords falling into the upper right section 405-2 are both good, thus it is recommended to maintain such promotion in the upper right section 405-2; in the upper left section ranking visibility factor for “Airline A” is good but the trending factor is poor, thus it is recommended that the keywords in the upper left section 405-1 require an increase in trending factor; and in the lower right section 405-4 trending factor for “Airline A” is good but the ranking visibility factor is poor, thus it is recommended that investment in the keywords be increased.

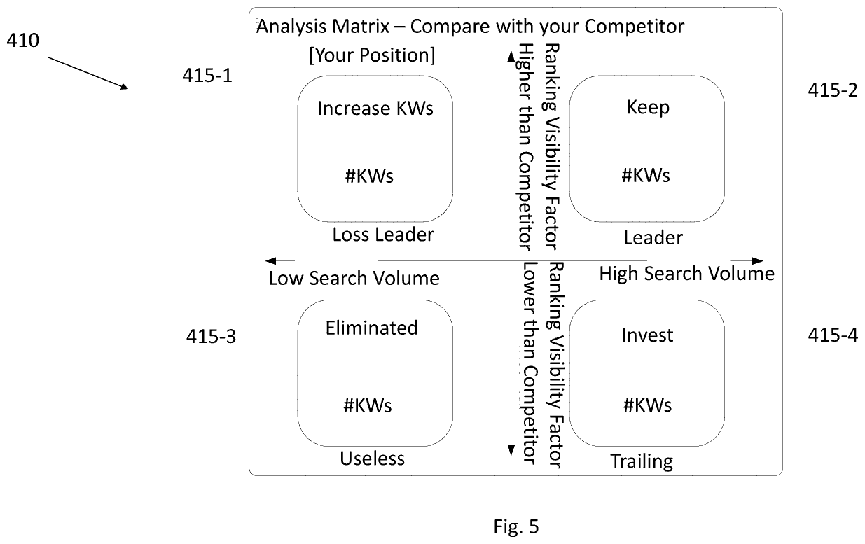

FIG. 5 shows a two-dimensional matrix analysis diagram 410 based on the trending factor (shown as search volume) and the ranking visibility comparison factor. In the present embodiment, the horizontal axis represents the trending factor, and the ranking visibility factor of the vertical axis is determined according to the comparison result of the underlying subject with the competitor's ranking visibility factor, wherein the higher the vertical coordinate, the better the ranking visibility factor of the underlying subject than that of the competitor.

Referring to FIG. 5, “Airline A” is likely to fall below the competitors based on the ranking visibility index based on the keywords in the lower left section 415-3 and the trending factor is poor, thus, it is not recommended to continue to promote the consumer keywords in the lower left section 415-3. The airline's ranking visibility factor based on the keywords in the upper right section 415-2 is better than the competitors and the trending factor is high, thus it is recommended to continue to maintain the budget until the ranking visibility factor decreases. The ranking visibility factor calculated based on the keywords in the upper left section 415-1 is better than the competitors but the trending factor is poor, thus it is recommended that the keywords in the upper left section 415-1 be expanded to comprehensively cover the keywords that are meaningful to the consumer. “Airline A” is less likely to appear in a search given the ranking visibility factor based on the keywords in the lower right section 415-4 but the trending factor is high, thus the performance needs to improve.

Therefore, the two-dimensional analysis diagram 410 clearly displays the customer's own performance and the relationship with the competitor and provides the corresponding delivery strategy according to different sections allowing a customer to determine which keywords are worth delivering and which are not worth delivering. In addition, the technical solution of the embodiments of the present invention further include understanding the dynamic performance of each keyword over a period of time by monitoring within a preset time period thereby permitting the customer to adjust the investment direction and the budget.

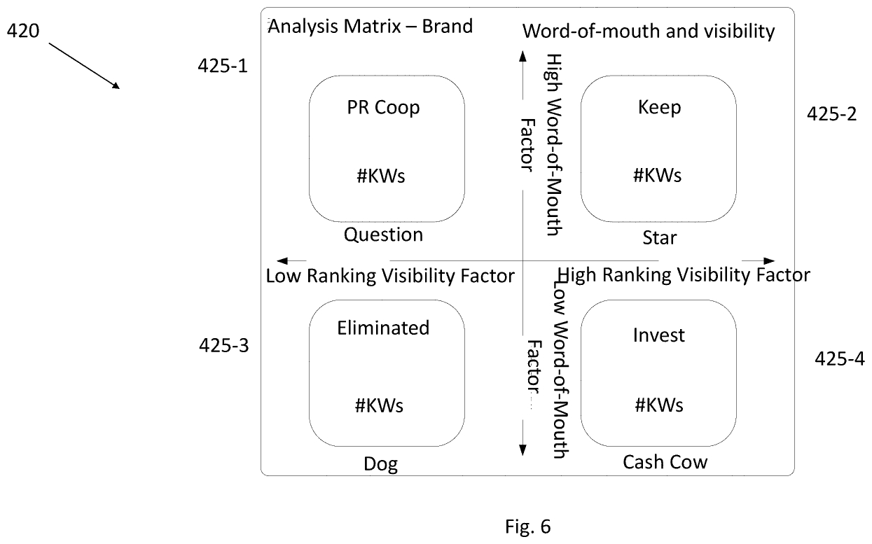

FIG. 6 shows a two-dimensional analysis diagram 420 based on ranking visibility factor and word-of-mouth factor. In the present embodiment, among the four sections 425-1 through 425-4 into which the diagram 420 is divided, the ranking visibility factor word-of-mouth factor calculated for the underlying subject according to the keywords in the upper right section 425-2 are superior, thus it is recommended to maintain the current word-of-mouth factor and ranking visibility factor level; the word-of-mouth factor is good for the keywords in the upper left section 425-1 but the ranking visibility factor is poor, thus it is recommended to improve the ranking visibility factor; the word-of-mouth factor is poor and the ranking visibility factor is poor in the lower left section 425-3, thus it is recommended to improve the word-of-mouth factor and ranking visibility factor with new keywords; and the ranking visibility factor is good for the keywords in the lower right section 425-4 but the word-of-mouth factor is poor, thus it is recommended to improve the word-of-mouth factor in a targeted manner while maintaining the ranking visibility factor. The two-dimensional diagram 420 assists the customer to clearly understand the current word-of-mouth factor and ranking visibility factor thereby helping the customer to adjust the investment strategy in real time.

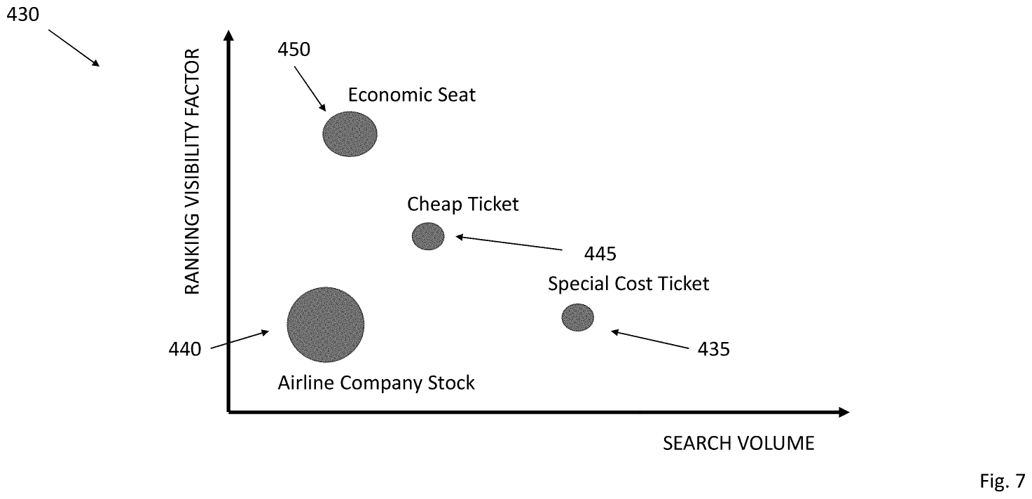

FIG. 7 shows a multi-dimensional analysis diagram 430 based on trending factor (shown as search volume), ranking visibility factor and word-of-mouth factor. In the present embodiment, the horizontal axis represents the trending factor, the vertical axis represents the ranking visibility factor, and the circle area diameter represents the level of word-of-mouth. For example, “Airline A” has a high trending factor based on the keyword “Special Cost Ticket” 435 but a low, ranking visibility factor and poor word-of-mouth factor. The trending factor and ranking visibility factor calculated according to the keyword “Airline Company Stock” 440 is low but the word-of-mouth factor is good. The keyword “Cheap Ticket” 445 results in a low word-of-mouth factor and average ranking visibility factor and trending factor while the keyword “Economic Seat” results in low trending factor but good word-of-mouth factor and ranking visibility factor.

Therefore, the multi-dimensional analysis diagram 430 directly illustrates the effect of each keyword through the trending factor, the ranking visibility factor and the word-of-mouth factor providing a thorough analysis of the parameters affecting the influence of the digital presence of the underlying subject.

One of ordinary skill in the art will appreciate that all or part of the steps to implement the various method embodiments described above can be accomplished by hardware associated with a computer program. The aforementioned computer program can be stored in a computer readable storage medium. The program, when executed, performs the steps including the foregoing method embodiments; and the foregoing storage medium includes various media that can store program codes, such as a ROM, a RAM, a magnetic disk, or an optical disk.

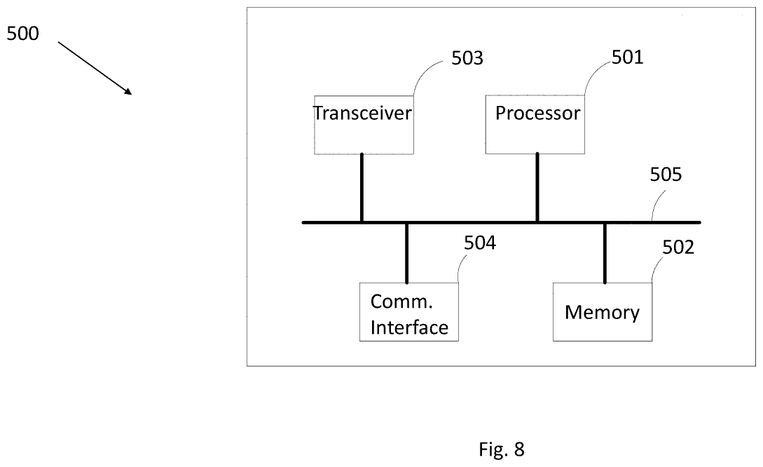

FIG. 8 shows a schematic structural diagram 500 of an electronic terminal in an embodiment of the present invention. The electronic terminal provided by the present example includes: a processor 501, a memory 502, a transceiver 503, a communication interface 504, and a system bus 505. The memory 502 and the communication interface 504 are connected to the processor 501 and the transceiver 503 through the system bus 505. The memory 502 is used to store computer programs, the communication interface 504 and the transceiver 503 are used to communicate with other devices, and the processor 501 is used to run a computer program to cause the electronic terminal to perform various steps of the above-described influence detection method.

The system bus 505 mentioned above may be a Peripheral Component Interconnect (PCI) bus or an Extended Industry Standard Architecture (EISA) bus. The system bus can be divided into an address bus, a data bus, a control bus and the like. For ease of representation, only one thick line is shown in the figure, but it does not mean that there is only one bus or one type of bus. The communication interface is used to implement communication between the database access device and other devices such as clients, read-write libraries and read-only libraries. The memory may include random access memory (Random Access Memory, RAM for short), and may also include non-volatile memory, such as at least one disk storage.

The above processor may be a general-purpose processor, including a central processing unit (CPU), a network processor (Network Processor, NP for short), and the like; or a digital signal processor (DSP), an application specific integrated circuit (DSP). Application Specific Integrated Circuit (ASIC), Field-Programmable Gate Array (FPGA) or other programmable logic devices, discrete gate or transistor logic devices, discrete hardware components.

In summary, the embodiments of present invention provide an influence detection method, an electronic terminal, and a storage medium suitable for an underlying subject and has the following beneficial effects: the embodiments of the present invention are based on a plurality of influence evaluation parameters such as word-of-mouth factor, ranking visibility factor, appearance percentage and trending factor. The intensity of the influence of the underlying subject effectively and comprehensively evaluates the brand's network influence. Therefore, the embodiments of the present invention effectively overcome various shortcomings in the prior art and has high industrial utilization value.

The embodiments of the present invention may be used to measure the degree of dissemination of digital documents via a computer readable storage medium and terminal. It should be noted that the digital documents as described herein refer to a document that exists in an electronic form on a network, such as an article, manuscript, video material, audio material, picture, etc. The degree of dissemination described herein refers to the degree of network-based or Internet dissemination of digital content. The following describes the embodiments and implementation principles of the present invention by referring to a digital document being disseminated.

The evaluation method described herein specifically includes analyzing whether a digital document published by a creator on one or more websites is further disseminated to other websites; and confirming the validity of the digital document on one or more websites to measure the effectiveness of the dissemination of the digital document.

The analysis of dissemination relates to analyzing whether the digital document is republished by additional websites after the initial publication of the digital document by the creator and if the number of websites publishing the digital document is greater than the number of websites on which the digital document was originally published.

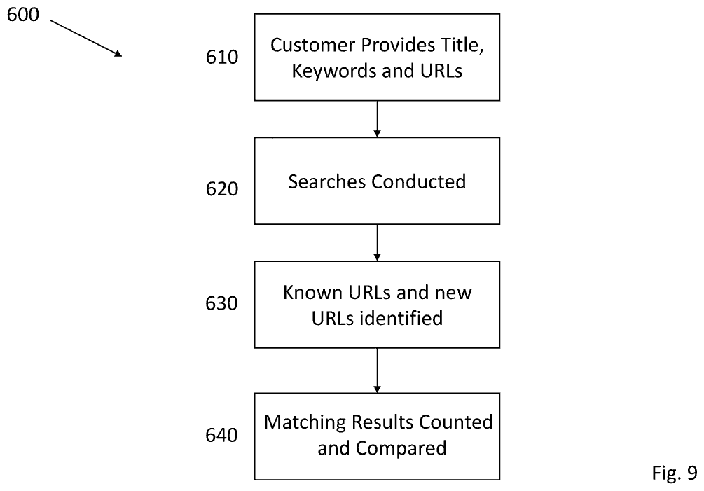

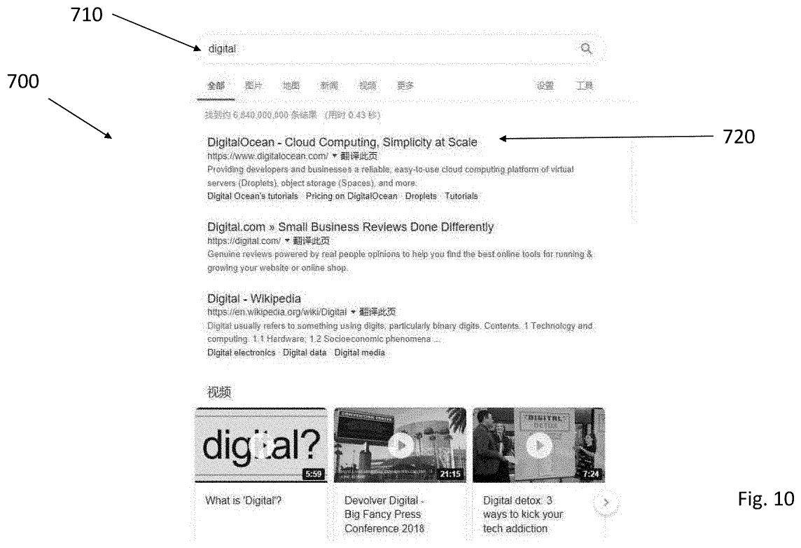

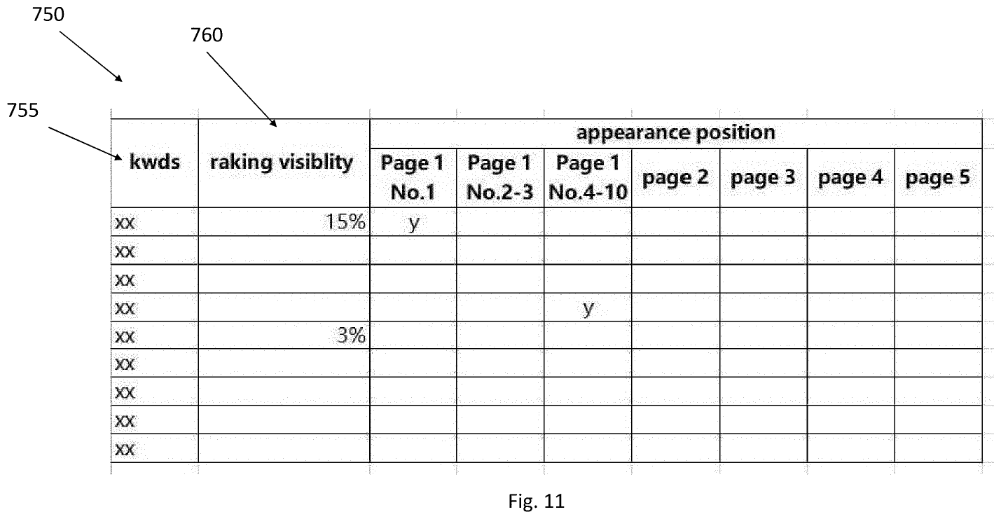

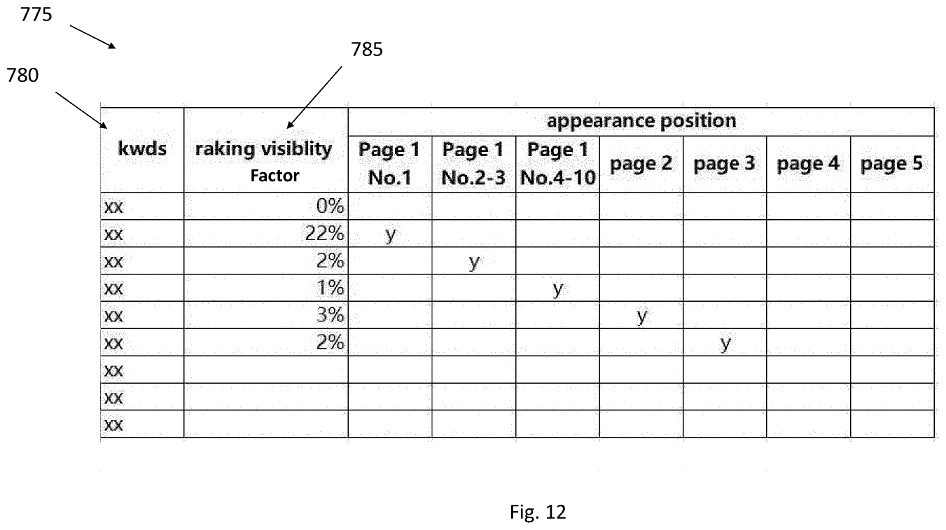

When a digital document is ready for publication, the creator posts the digital document on one or more websites thereby publishing the same. FIG. 9 shows a flowchart 600 detailing a method for measuring the degree of dissemination of a digital document. At 610, a customer provides the title of a digital document, keywords related to the topic of the digital document, and the URLs of the websites on which the customer published the digital document and the URL associated the search tool required by the customer. At 620, one or more Internet-based searches are conducted based on the keywords provided by the customer. FIG. 10 shows a search page 700 for a published digital document entitled Digital Ocean with the keyword being “digital” 710. The creator published the digital document on the website having the URL www.digitalocean.com. The first search result 720 corresponds to the published digital document. The smart/intelligent terminal uses the search result link to perform the following two tasks: (i) use the title and creator-provided URL to locate original websites on which the article was published (see FIG. 11 which shows a chart 750 of matching title and websites on which the digital document was originally published—original efficiency with keywords 755 and associated ranking visibility factor 760 based on the position and page of the search results) and (ii) identify via the title, other URLs having the digital document available (see FIG. 12 which shows a chart 775 of matching titles with new URLs not provided by the creator thus evidencing further dissemination—reprint efficiency with keywords 780 and associated ranking visibility factor 785 based on the position and page of the search results). In one embodiment, the searches based on the digital document title and the evaluation of the search results utilize a web crawler or similar program to automate the process. A web crawler, also known as a web spider or a web robot, is a program or script that automatically grabs web information according to certain rules.

In general, to improve the evaluation efficiency, the intelligent terminal selects the first n results (e.g., 30) of all search results for evaluation analysis. However, it should be noted that in other embodiments, n may represent any number of search results suitable to undertake the evaluation. In one embodiment, the value of n may be determined by the extent of the creator's publication. In other words, the more extensive the publication, the more search results that may be evaluated.

At 640, the number of search results matching the digital document are counted and compared to the number of search results corresponding to the published digital document. In this step, the smart terminal matches the selected n search results with the creator-provided title and the URLs of the publication websites. If the title of the publication and the creator-provided URL match, the search result is one of the original websites on which the digital document was published. If the title in the search result matches the title of the publication but the URL does not match, the search result is indicative of the digital document being disseminated (i.e., reprinted) to a new website. In one embodiment, the content of each search result including the matching title is evaluated to ensure it is not empty, garbled or otherwise invalid. A ranking visibility factor associated with the search results provides a basis for determining the efficiency of the digital document publication. The efficiency evaluation may then be used to coordinate the proper PR budget and/or determine best platform and on which websites to publish the digital document.

By way of example, it is first assumed that a customer publishes a digital document having the title “T” on websites A1, A2, . . . , A10. In one embodiment, the current system completes the following tasks: (1) conducts an internet search based on the title of the digital document wherein five search results matching the title are located on websites A1, A2, A3, A4 and A11; and (2) determines that the title associated with websites A1, A2, A3 and A4 match the digital document and original URLs on which is was published while the digital document on website A11 is a new dissemination.

If the number of search results is greater than the number of published works, the evaluation of the dissemination of the digital document is deemed effective (i.e., the spread of the digital document). That is, if the number of digital documents matched by the smart terminal in the n search results is greater than the number of digital documents originally published by the creator, it is indicative of the digital document being reprinted, thereby proving that the digital document is spreading. However, it should be noted that if the number of digital documents matched by the smart terminal in the n search results is less than or equal to the number of digital documents originally published by the creator, it is indicative of the digital document being ineffectively disseminated on the required website. Taking the above embodiment as an example, although the final count of the number of digital documents matching the digital documents published by the creator is only four (i.e., less than the number of digital documents originally published), website A11 is not included in the website published by the customer, so website A11 belongs to the digital document obtained by reprinting. Therefore, in this case, although the number of digital documents located by the search is less than the number of digital documents originally published and since the digital documents have been reprinted, it is part of an effective dissemination. In another embodiment, if the digital document in the search results is not reprinted, and the number of search results is less than the number of publications of the digital document, it is indicative of the digital document having not been reprinted.

The evaluation method provided by the embodiments of the present invention is more comprehensive than detecting the degree of network dissemination of the digital document by detecting whether the digital document has been deleted or not as set forth in the prior art. The embodiments of the present invention may also consider the digital document reading volume and whether the digital document has been deleted, reprinted, the feedback and various weighted parameters to comprehensively evaluate the degree of dissemination of the digital document. The embodiments of the present invention avoid human-manipulatable data and provides a true position of a digital document. Moreover, the embodiments of the present invention permit a specific search tool (e.g., Google®) to determine search results and the dissemination of the digital document via that specific search tool and the same holds true for a specific social platform.

As described above, the embodiments of the present invention cannot only measure the degree of dissemination of the digital document by measuring the extensibility of the digital document but can also evaluate the effectiveness of the digital document (by using keywords which relate to the digital document). The following is a detailed explanation of how to evaluate the effectiveness of the digital document.

Every digital document has its purpose, such as a digital document created for a makeup brand's powerful hydrating function or for the power-saving features of a home appliance brand. After the digital document is published, there are generally two methods for finding the digital document. The first method is to access the digital document on the publishing websites while the second method is to search for the digital document according to a keyword. The first method is limited in that the consumer must locate the publishing websites to view the digital document whereas the second method is more reasonable and practical. Therefore, the embodiments of the present invention are directed to the second method.

For example, referring to digital document created for the powerful hydrating function of a makeup brand, consumers can locate multiple search results by entering the keywords “what mask is best for hydrating” on an Internet search tool. By analyzing whether the digital document created for a makeup brand's powerful hydration function can be found in all or some of the search results. Moreover, the search position of the digital document amongst the search results can be used to further explain the degree of dissemination of the digital document.

Using all the public relations digital documents published by a customer over the previous year as an example, the system obtains the digital document title, the digital document URL and the keywords for each digital document, the system performs the following evaluation. Step 1: imports the four elements of the title of the digital document, the URL of the digital document publication website, the keywords for each digital document and the search website (e.g., Google®) selected by the client. Step 2: uses a web crawler to crawl the n-page or n-line search results according to the keyword search on the search function-enabled website on which the digital document was searched. Step 3: using the title and URL to find the position of published digital documents from which a ranking visibility factor may be used to determine the effectiveness of the publication.

By way of example, a customer publishes three public relations digital documents entitled “A brand smart watch is more comfortable” published on a first website (W1), and a public relations digital document entitled “A brand smart watch is more beautiful” published on the second website (W2) and a public relations digital document entitled “A Smart Watch for Smart Brands” published on a third website (W3). If conducting an Internet search using keywords “smart watch” and assuming fifty search results are obtained with only the title and URLs of the first two digital documents matching the public relations digital documents published by the customer, two results are positive and forty-eight are negative the system may use the position of the relative positions of the matched digital documents to determine the ranking visibility factor and overall effectiveness of each published digital document based on the keywords.

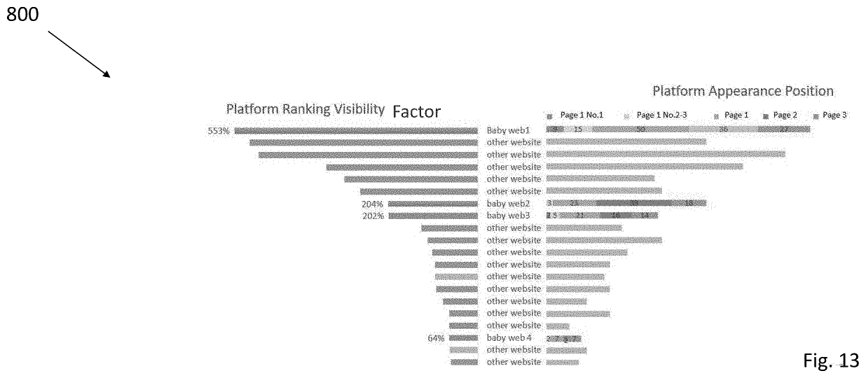

FIG. 13 shows a chart 800 for visualizing a website's effectiveness in terms of analyzing search results based on keywords according to the embodiments of the present invention. As shown on the left-hand side of the chart 800, baby website 1 has the highest-ranking visibility factor (553%). Baby websites 2, 3 and 4 have lessor ranking visibility factors. Given the same costs, baby website 1 is the best value. Between baby websites 2 and 3, baby website 3 is a better value given the same ranking visibility factor but better appearance positions within the search results as shown on the right-hand side of the chart 800.

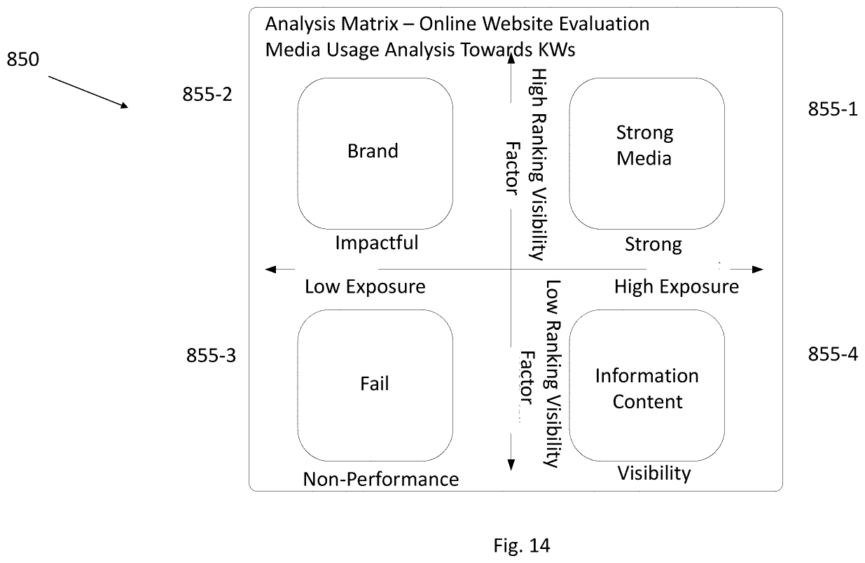

FIG. 14 illustrates a chart 850 listing ranking visibility factor against exposure to identify a website's effectiveness relative to certain keywords according to the embodiments of the present invention. The upper right quadrant 855-1 of chart 850 represents a keyword having a high ranking visibility factor and high exposure thus is suitable for strong media; the lower right quadrant 855-4 represents a website having a low ranking visibility factor and high exposure thus is suitable for information content; the upper left quadrant 855-2 represents a keyword having a high ranking visibility factor and low exposure thus is suitable for brand; and the lower left quadrant 855-3 represents a keyword having a low-ranking visibility factor and low exposure thus is not worthy of expense.

The above-described embodiments are merely illustrative of the principles of the invention and its effects and are not intended to limit the invention. Modifications or variations of the above-described embodiments may be made by those skilled in the art without departing from the spirit and scope of the invention. Therefore, all equivalent modifications or changes made by those skilled in the art without departing from the spirit and scope of the invention are still to be covered by the appended claims.

Although the invention has been described in detail with reference to several embodiments, additional variations and modifications exist within the scope and spirit of the invention as described and defined in the following claims.

I claim:

1. A method for evaluating the degree of dissemination of a digital document on the Internet, comprising:
(i) receiving a title of said digital document, URLs representing websites on which the digital document was published and one or more keywords related to said digital document;
(ii) conducting an Internet search using said received one or more keywords;
(iii) identifying a match between received URLs and said title of said digital document during the Internet search to determine the efficiency of the publication and identifying new URLs of websites having the digital document to determine the efficiency of the dissemination of the digital document.

2. The method for evaluating the degree of dissemination of a digital document on the Internet according to claim 1, further comprising:
conducting an Internet search based on one or more keywords;
classifying search result sets according to names of websites;
calculating an effective value of each website in the search result sets;
summing said effective values to obtain a total ranking visibility factor; and
sorting websites based on said ranking visibility factor.

3. The method for measuring the degree of dissemination of a digital document on the Internet according to claim 1 wherein a formula for an effective value of the website is as follows:
$${sum\_pct}_{{weight}_{ij}} = {\sum }_{\sum p c {t}_{{weight}_{ij}}} ;$$
wherein, Σpct_{weight}_{ᵢⱼ} is a valid value of each media website in each keyword search result set and wherein
$${\sum }_{\sum p c {t}_{{weight}_{ij}}}$$
represents the sum or effective values of each media website the keyword search result sets.

4. The method for measuring the degree of dissemination of a digital document on the Internet according to claim 1 wherein a formula for cost effectiveness of the dissemination is as follows: CPV=Cost/Sum_pct_{weightij} wherein Cost represents the cost of investing in the website.

5. A computer readable storage medium having stored thereon a computer program, wherein the program is executed by a processor for:
(i) receiving a title of a digital document, URLs representing websites on which the digital document was published and one or more keywords related to the digital document;
(ii) conducting an Internet search using said received one or more keywords;
(iii) identifying a match between received URLs and the title of said digital document during the Internet search to determine the efficiency of the publication and identifying new URLs of websites having the digital document to determine the efficiency of the dissemination of the digital document.

6. A computer readable storage medium having stored thereon a computer program according to claim 5 wherein the program is further executed by a processor for:
conducting an Internet search based on one or more keywords;
classifying search result sets according to names of websites;
calculating an effective value of each website in the search result sets;
summing said effective values to obtain a total ranking visibility factor; and
sorting websites based on said ranking visibility factor.

7. A computer readable storage medium having stored thereon a computer program according to claim 5 wherein the program is further executed by a processor for:
using a formula for an effective value of the website as follows:
$${sum\_pct}_{{weight}_{ij}} = {\sum }_{\sum p c {t}_{{weight}_{ij}}} ;$$
wherein, Σpct_{weightij} is a valid value of each media website in each keyword search result set and wherein
$${\sum }_{\sum p c {t}_{{weight}_{ij}}}$$
represents the sum of effective values of each media website the keyword search result sets.

8. A computer readable storage medium having stored thereon a computer program according to claim 5 wherein the program is further executed by a processor for:
using a formula for cost effectiveness of the dissemination as follows: CPV=Cost/Sum_pct_{weightij} wherein Cost represents the cost of investing in the website.
